(19) United States
(12) Patent Application Publication
(10) Pub. No.: US 2007/0095038 A1
(43) Pub. Date: May 3, 2007

(54) Filtration structure, in particular a particulate filter for exhaust gases of an internal combustion engine and a reinforcement element intended for such a structure

(76) Inventors: Sebastien Bardon, Lyon (FR); Dominique Dubots, Sallanches (FR)

Correspondence Address: SUGHRUE MION, PLLC, 2100 PENNSYLVANIA AVENUE, N.W., SUITE 800, WASHINGTON, DC, 20037, US

(21) Appl. No.: 10/596,656

(22) PCT Filed: Dec. 16, 2004
(86) PCT No.: PCT/FR04/03263

§ 371 Date: Oct. 4, 2006

(30) Foreign Application Priority Data
Dec. 24, 2003 (FR) 0315407

(51) Int. Cl. B01D 46/00

(52) U.S. Cl. 55/523

(57) ABSTRACT

The invention relates to a filtration structure (11) consisting of: first and second filtration elements (15A, 15B) which comprise respectively a first face and a second face (24A, 24B), said faces being disposed opposite one another; and a connecting joint (17) which extends between the faces (24A, 24B) and connects same. The aforementioned joint (17) comprises a binder (41) and reinforcing means (43) which are embedded therein. The reinforcing means (43) comprise an open-work reinforcing member having an autonomous coherence and comprising an essentially-flat active part (45). The invention is suitable for particle filters for the exhaust gases from an internal combustion engine.

The present invention relates to a filtration structure, in particular a particulate filter for exhaust gases of an internal combustion engine, of the type comprising:

at least first and second filtration elements which have a first and second face which are arranged opposite each other, respectively;

a joint for connecting the faces which extends between the faces, this joint comprising a binding agent and reinforcement means which are embedded in this binding agent.

Structures of this type are used in particular in devices for cleaning the exhaust gases of internal combustion engines. These devices comprise an exhaust silencer which comprises in series a catalytic purification element and a particulate filter. The catalytic purification element is suitable for processing polluting emissions in a gaseous phase, whilst the particulate filter is suitable for retaining the particulates of soot discharged by the engine.

In a known structure of the above-mentioned type (see, for example, EP-A-0 816 065), the filtration elements comprise a group of adjacent conduits which have parallel axes and which are separated by means of porous filtration walls. These conduits extend between an inlet face for the exhaust gases to be filtered and a discharge face for the filtered exhaust gases. These conduits are further closed at one or other of the ends thereof in order to delimit inlet chambers which open at the inlet face and outlet chambers which open at the discharge face.

This structure operates in accordance with a series of filtration and regeneration phases. During the filtration phases, the soot particulates discharged by the engine are deposited on the walls of the inlet chambers. The pressure drop through the filter increases gradually. Beyond a predetermined value for this pressure drop, a regeneration phase is carried out.

During the regeneration phase, the soot particulates, which substantially comprise carbon, are burnt on the walls of the inlet chambers using auxiliary heating means in order to restore the original properties of the structure.

However, the combustion of the soot in the filter is not carried out in a homogeneous manner (the combustion begins at the front and at the centre of the filter and then spreads) Consequently, high temperature gradients appear in the filter during the regeneration phases.

The temperature gradients within the filtration structure produce local occurrences of expansion of different magnitudes and consequently longitudinal and transverse stresses in and/or between the various filtration elements.

These high levels of thermomechanical stress bring about cracks in the filtration elements and/or in the connection joints between these filtration elements.

In order to limit the risk of these cracks appearing, patent application EP-A-0 816 065 proposes that connection joints be used which comprise a three-dimensional network of ceramic fibres embedded in a mineral cement. The cohesion of the network of fibres and the connection between this network and the cement are brought about by substances for adhesively-bonding the fibres, one of which is mineral, the other organic.

Current structures are not entirely satisfactory. The use of a joint of this type between the filtration elements is not very practical owing in particular to the rheology of the joint.

The main object of the invention is to overcome this disadvantage, that is to say, to provide, for a particulate filter, a porous filtration structure which comprises a reinforced connection joint and which is easy to use.

To this end, the invention relates to a filtration structure of the above-mentioned type, characterised in that the reinforcement means comprise at least one mesh-like reinforcement element which has independent coherence and which comprises at least one active portion which is generally of substantially planar form.

The filtration structure according to the invention may comprise one or more of the following features, taken in isolation or according to any technically possible combination:

the active portion comprises a plurality of beams which are arranged substantially parallel with a first direction;

the active portion comprises a plurality of cross-members which connect the beams and which are arranged substantially parallel with a second direction, distinct from the first direction;

the total volume of the apertures delimited by the beams and the cross-members is greater than the total volume of the beams and the cross-members;

the reinforcement element is produced from a metal material;

the reinforcement element is produced from a material which degrades at temperatures greater than 150° C.;

the reinforcement element comprises an active portion opposite two adjacent faces of the filtration element, the active portions being connected to each other;

it comprises at least one cell which comprises four filtration elements, and a common reinforcement element, having a sinuous shape, for the filtration elements, the common reinforcement element comprising at least three successive active portions which are arranged opposite adjacent faces of the filtration elements of the cell;

it comprises at least first and second cells, at least one active portion of the reinforcement element of the first cell being arranged opposite a face of a filtration element of the second cell.

The invention further relates to a reinforcement element which is intended for a filtration structure as defined above.

Application examples of the invention will now be described with reference to the appended drawings, in which:

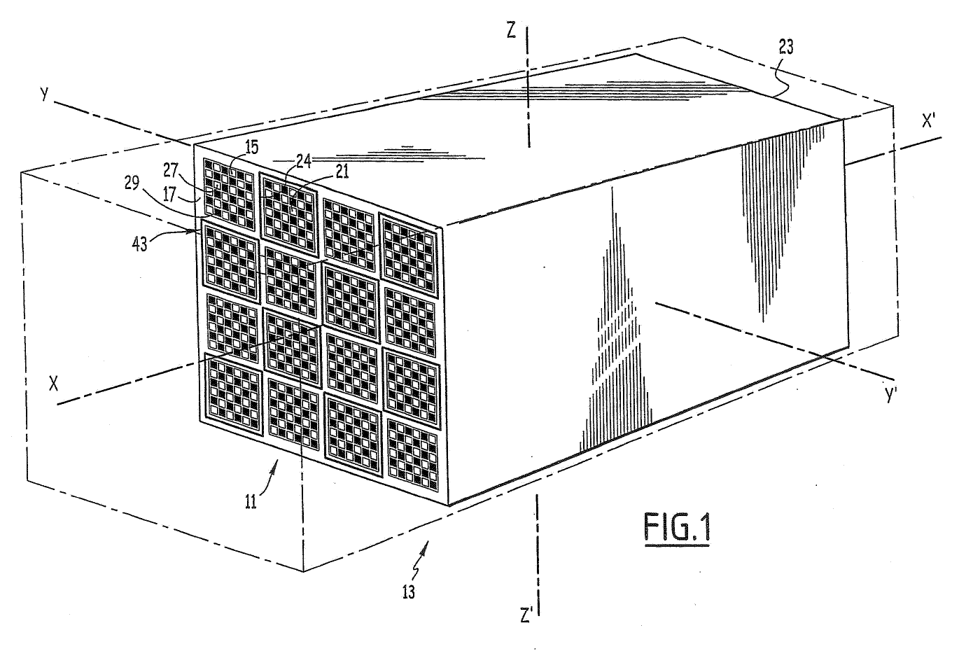

FIG. 1 is a perspective view of a first filtration structure according to the invention;

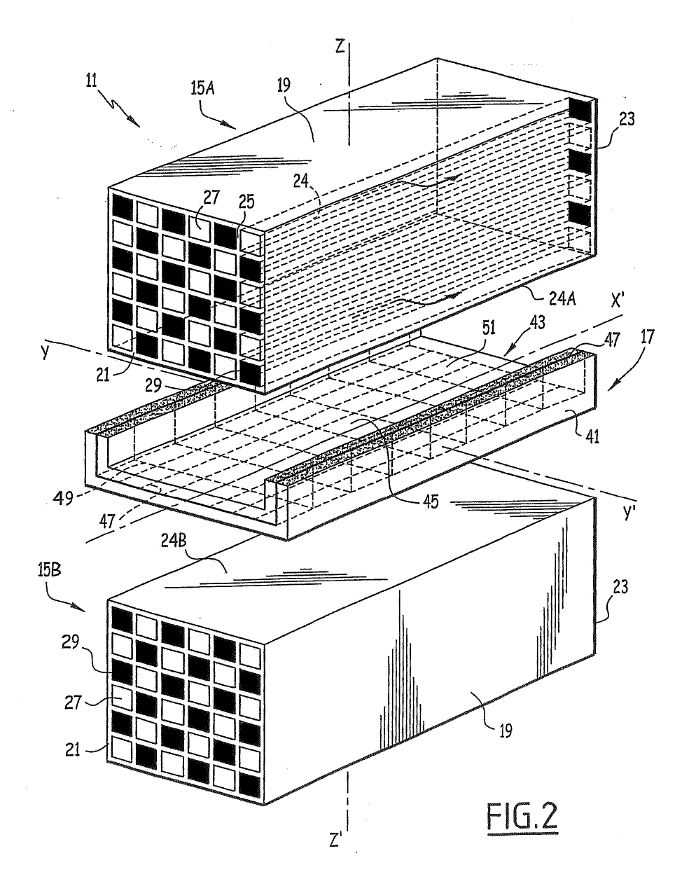

FIG. 2 is an exploded partial perspective view of the filtration structure of FIG. 1;

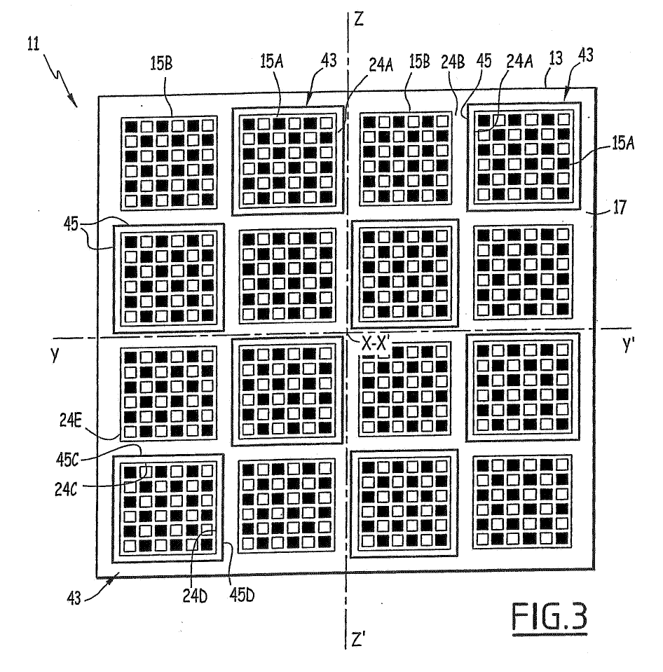

FIG. 3 is an end view of the filtration structure of FIG. 1; and

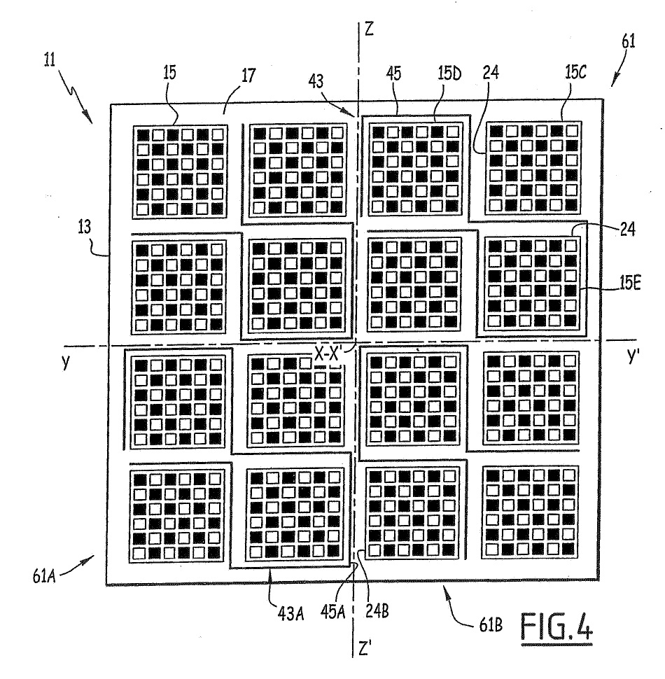

FIG. 4 is a view similar to FIG. 3, of a second filtration structure according to the invention.

The particulate filter 11 illustrated in FIG. 1 is arranged in a partially illustrated exhaust tract 13 of a motor vehicle diesel engine.

This exhaust tract 13 extends beyond the ends of the particulate filter 11 and delimits a passage for circulation of the exhaust gases.

The particulate filter 11 extends in a longitudinal direction X-X′ for circulation of the exhaust gases. It comprises a plurality of filtration units 15 which are connected to each other by means of connection joints 17.

Each filtration unit 15 has a substantially parallelepipedal rectangular form which is elongate in the longitudinal direction X-X′.

The term “filtration unit” more generally refers to an assembly comprising an inlet face, an outlet face, and at least three lateral faces (four lateral faces in the example illustrated) which connect the inlet face to the outlet face.

As illustrated in FIG. 2, in which two superimposed filtration units 15A and 15B are illustrated, each filtration unit 15 comprises a porous filtration structure 19, an inlet face 21 for the exhaust gases to be filtered, a discharge face 23 for the filtered exhaust gases and four lateral faces 24.

The porous filtration structure 19 is produced from a filtration material which is constituted by a monolithic structure, in particular ceramic material (cordierite or silicon carbide).

This structure 19 is sufficiently porous to allow the exhaust gases to pass through. However, as known per se, the diameter of the pores is selected to be sufficiently small to ensure that the soot particulates are retained.

The porous structure 19 comprises an assembly of adjacent conduits having axes which are parallel with the longitudinal direction X-X′. These conduits are separated by porous filtration walls 25. In the example illustrated in FIG. 2, these walls 25 are of a constant thickness and extend longitudinally in the filtration structure 19, from the inlet face 21 to the discharge face 23.

The conduits are distributed in a first group of inlet conduits 27 and a second group of outlet conduits 29. The inlet conduits 27 and the outlet conduits 29 are arranged transposed.

The inlet conduits 27 are closed in the region of the discharge face 23 of the filtration unit 15 and are open at their other end.

Conversely, the outlet conduits 29 are closed in the region of the inlet face 21 of the filtration unit 15 and open along the discharge face 23 thereof.

In the example illustrated with reference to FIG. 2, the inlet conduits 27 and outlet conduits 29 have constant cross-sections along the entire length thereof.

Furthermore, the opposing lateral faces 24A and 24B of the filtration units 15A and 15B are planar.

As illustrated in FIG. 2, the connection joint 17 is arranged between the opposing planar faces 24A and 24B of the filtration units 15A and 15B. This connection joint 17 comprises a binding agent 41 and reinforcement means 43 which are embedded in this binding agent 41.

The binding agent 41 is produced based on ceramic cement which is generally constituted by silica and/or silicon carbide and/or aluminium nitride. After sintering, this cement has an elastic modulus of from 500 to 5000 MPa.

As illustrated in FIG. 3, the reinforcement means comprise sleeves 43 which are arranged alternately around every other filtration unit 15 when moving parallel with a first transverse axis Y-Y′ of the filtration structure 11 (horizontal in FIG. 3). Furthermore, the sleeves 43 are arranged alternately around every other filtration unit 15A when moving parallel with a second transverse axis Z-Z′ of the structure 11 (vertical in FIG. 3).

Each filtration unit 15A surrounded by a sleeve 43 is thus adjacent to filtration units 15B which are free, that is to say, which are not surrounded by a sleeve 43. Furthermore, each free filtration unit 15B is adjacent to filtration units 15A which are surrounded by sleeves.

Each sleeve 43 comprises four active portions 45 which generally have a substantially planar form and each of which extends substantially over the entire adjacent surface of the corresponding unit 15A.

“Active portion generally having a substantially planar form” is understood to be a portion 45 whose dimension, taken parallel with a transverse horizontal or vertical axis Y-Y′ or Z-Z′ is less than at least twice the dimension of the portion 45 taken parallel with the other transverse vertical or horizontal axis and the dimension of the portion 45, taken parallel with the longitudinal direction X-X′ of the filtration structure 11.

As illustrated in FIG. 3, each active portion 45 is arranged between a face 24A of a unit 15A which is surrounded by a sleeve 43 and a face 24B of a free unit 15B.

With reference to FIG. 2, each active portion 45 comprises a plurality of metal beams 47 which are arranged parallel with the longitudinal direction X-X′ of the structure. Furthermore, the active portion 45 comprises a plurality of metal cross-members 49 which connect the beams 47. These cross-members 49 are arranged parallel with the transverse axis Y-Y′, perpendicular relative to the longitudinal direction X-X′ of the structure.

The beams 47 and the cross-members 49 thus delimit a plurality of apertures 51. The active portion 45 is thus mesh-like, which allows it to be embedded in the cement 41, and has its own or independent coherence or mechanical strength, in contrast to a mass of fibres which are embedded in the cement in a random manner.

In the example illustrated in FIG. 2, the beams 47 and the cross-members 49 are constituted by rods having a diameter which is smaller than the distance which separates two successive rods, taken parallel with the longitudinal direction X-X′ of the structure or the transverse axis Y-Y′. Thus, the volume of the apertures 51 is greater than the total volume of the beams 47 and the cross-members 49.

These apertures 51 thus define a periodic structure in the longitudinal direction X-X′ and along the axis Y-Y′.

The orientation of the beams 47 and the cross-members 49 enhances the mechanical properties of the joint 17 in a plane parallel with the opposing faces 24A and 24B of the filtration units 15A and 15B.

Furthermore, since the beams 47 and the cross-members 49 are produced from a metal material, they constitute preferred axes for propagation of thermal fluxes within the joint 17. They thus allow the heat released by the combustion of soot to be distributed in a more uniform manner within the joint 17 and the formation of hot spots within this joint 17 to be reduced.

If the levels of thermomechanical stress are too great in the structure 11, the cracks produced in the joint 17 by the relaxation of the structure 11 are orientated along the beams 47 and the cross-members 49.

As illustrated in FIG. 3, the active portions 45C and 45D opposite two adjacent faces 24C and 24D of each unit 15 surrounded by a sleeve 43 are connected to each other. This specific arrangement also improves the cohesion of the joint 17 between two opposing faces 24C and 24E in a direction which is orthogonal relative to the plane defined by the active portion 45C which is arranged between these two faces 24C and 24E.

The operation of the first filtration structure according to the invention will now be described.

During a filtration phase (FIG. 1), the exhaust gases which are loaded with particulates are guided as far as the inlet faces 21 of the filtration units 15 via the exhaust tract 13. They then enter the inlet conduits 27 and pass through the walls 25 of the porous structure 19 (FIG. 2). During this movement, soot is deposited on the walls 25 of the inlet conduits 27. This soot is preferably deposited at the centre of the particulate filter 11 and towards the discharge face 23 of the filtration units 15 (on the right-hand side in the drawing).

The filtered exhaust gases are discharged via the discharge conduits 29 and are guided to the outlet of the exhaust silencer.

When the vehicle has travelled approximately 500 km, the pressure loss through the filter 11 increases significantly. A regeneration phase is then carried out.

During this phase, the soot is oxidised by means of the temperature of the filter 11 being increased. This oxidation is exothermic. The propagation of the regeneration and the non-homogeneous distribution of the soot in the filter 11 brings about a temperature gradient between the zones in which there is a significant accumulation of soot and zones in which there is little accumulation of soot.

Furthermore, the filtration units 15 and the joints 17 expand under the effect of the temperature. The local extent of this expansion depends on the temperature.

These variations in the magnitude of expansion, under the effect of the temperature gradients, produce high levels of thermomechanical stress.

As set out above, the sleeves 43 bring about the cohesion of the joint 17 when it is subjected to these high levels of, stress.

If the levels of thermomechnical stress are too great in the structure, the cracks produced in the joint 17 by the relaxation of the structure 11 are orientated along the beams 47 and the cross-members 49 of the sleeves 43.

Furthermore, the extent of the temperature gradients is reduced by a better diffusion of the thermal fluxes through the sleeves 43.

In the variant which is illustrated with reference to FIG. 4, the structure comprises cells 61 which comprise four adjacent filtration units 15.

Within a cell, each filtration unit 15C comprises two adjacent faces 24 opposite two faces of two other filtration units 15D, 15E of the cell 61, respectively.

Each cell 61 further comprises a common reinforcement element 43 for the four filtration units 15.

As illustrated in FIG. 4, the reinforcement element 43 of each cell has a sinuous form and comprises a plurality of successive active portions 45 of substantially planar form which are connected to each other in series.

Each active portion 45 is thus connected to a maximum of two other active portions 45 of the reinforcement element 43.

Furthermore, the active portions 45 which are connected to each other extend along orthogonal planes.

Consequently, within each cell 61, the reinforcement element 43 comprises at least two active portions 45 opposite two adjacent faces 24 of each filtration unit 15, respectively.

The cohesion within a filtration cell 61 is thus enhanced parallel with the longitudinal direction X-X′ of the structure 11, parallel with the horizontal axis Y-Y′ and parallel with the vertical axis Z-Z′ of this structure 11.

Furthermore, the filtration structure 11 comprises a plurality of cells 61. As illustrated in FIG. 4, for each pair of adjacent cells, at least one active portion 45A of the reinforcement element 43A of a first cell 61A is arranged opposite a face 24B of a filtration unit 15B of a second adjacent cell 61B, in order to provide the mechanical cohesion between the various cells 61.

In a variant, the beams 47 and the cross-members 49 may have other orientations, for example, at 45° relative to the axes X-X′ and Y-Y′ or at 30° relative to one of these axes.

Also in a variant, the reinforcement element comprises active portions which are formed from a woven web. The woven web is produced from fibres which are, for example, organic and which degrade at temperatures greater than 150° C.

This reinforcement element disappears owing to combustion, either during the production of the filtration structure, or during local heating within the joint. However, the passages which are created in the space which was previously occupied by the organic fibres of the reinforcement element promote the relaxation of the stresses in the filtration joint and, if the levels of thermomechanical stress are too great, ensure that any cracks are spread along these passages.

In another variant, the active portions of the reinforcement element comprise mesh-like plates or undulating mesh-like sheets in order to reduce the magnitude of the thermal gradients within the structure.

Owing to the invention which has been described above, it is possible to have a filtration structure which can withstand a multitude of regeneration phases whilst retaining its mechanical strength and sealing with respect to the soot.

In this structure, the relaxation of the thermomechanical stresses and the possible formation of cracks in the joint are orientated in preferred directions.

This structure further provides a better distribution of the temperatures within the joint, if the reinforcement element is produced from a metal material.

1. Filtration structure (11), in particular a particulate filter for exhaust gases of an internal combustion engine of the type comprising:
at least first and second filtration elements (15A, 15B) which have a first and second face (24A, 24B) which are arranged opposite each other, respectively;
a joint (17) for connecting the faces (24A, 24B) which extends between the faces (24A, 24B), this joint (17) comprising a binding agent (41) and reinforcement means (43) which are embedded in this binding agent (41),
characterised in that the reinforcement means (43) comprise at least one mesh-like reinforcement element which has independent coherence and which comprises at least one active portion (45) which is generally of substantially planar form.

2. Structure (11) according to claim 1, characterised in that the active portion (45) comprises a plurality of beams (47) which are arranged substantially parallel with a first direction (X-X′).

3. Structure (11) according to claim 2, characterised in that the active portion (45) comprises a plurality of cross-members (49) which connect the beams (47) and which are arranged substantially parallel with a second direction (Y-Y′), distinct from the first direction (X-X′).

4. Structure (11) according to claim 3, characterised in that the total volume of the apertures (51) delimited by the beams (47) and the cross-members (49) is greater than the total volume of the beams (47) and the cross-members (49).

5. Structure (11) according to claim 1, characterised in that the reinforcement element (43) is produced from a metal material.

6. Structure (11) according to claim 1, characterised in that the reinforcement element (43) is produced from a material which degrades at temperatures greater than 150° C.

7. Structure (11) according to claim 1, characterised in that the reinforcement element (43) comprises an active portion (45C, 45D) opposite two adjacent faces (24C, 24D) of the filtration element, the active portions (45C, 45D) being connected to each other.

8. Structure (11) according to claim 1, characterised in that it comprises at least one cell (61) which comprises four filtration elements (15), and a common reinforcement element (43), having a sinuous shape, for the filtration elements (15), the common reinforcement element (43) comprising at least three successive active portions (45) which are arranged opposite adjacent faces (24) of the filtration elements (15) of the cell (61).

9. Structure (11) according to claim 8, characterised in that it comprises at least first and second cells (61A, 61B), at least one active portion (45A) of the reinforcement element (43A) of the first cell (61A) being arranged opposite a face (24B) of a filtration element (15B) of the second cell (61B).

10. Reinforcement element intended for a filtration structure according to claim 1.
